(19) United States
(12) Patent Application Publication
(10) Pub. No.: US 2016/0139238 A1
(43) Pub. Date: May 19, 2016

(54) SYSTEM AND METHOD FOR RFID INDOOR LOCALIZATION

(71) Applicant: QATAR UNIVERSITY QSTP-B, Doha (QA)

(72) Inventors: Abdelmoula BEKKALI, Doha (QA); Abdullah KADRI, Doha (QA)

(21) Appl. No.: 14/441,846

(22) PCT Filed: Jun. 20, 2013
(86) PCT No.: PCT/IB2013/055084

§ 371 Date: May 9, 2015

(51) Int. Cl. G01S 5/02; H01Q 1/00; G01S 13/75

(52) U.S. Cl. CPC G01S 5/0252; G01S 13/75; G01S 5/0278; H01Q 1/007

(57) ABSTRACT

Disclosed is a system for RFID indoor localization for estimating location of a target object in a localization area, comprising: a radio frequency identification (RFID) unit comprising a RFID reader and a plurality of RFID antennas in operative communication with the RFID reader; and a central unit in operative communication with the RFID unit. The central unit is capable of configuring and distributing a plurality of passive reference tags in the localization area and further capable of: collecting data from the passive reference tags through the RFID unit; processing the collected data; and estimating location of the target object. The central unit employs learning-based location estimation by received signal strength RSSI and detection rate fingerprinting of passive reference tags and the use of tags with different backscattered range.

### FIELD OF THE INVENTION

The present invention relates to systems and methods for radio frequency identification (RFID) indoor localization.

### BACKGROUND OF THE INVENTION

Indoor localization is a process of inferring the unknown location of a target object based upon measurements learned from environment. Generally, an indoor localization system (also known as indoor positioning system (IPS)) is a network of devices used to wirelessly locate objects or people inside a building. Instead of using satellites, an IPS relies on nearby anchors (nodes with a known position), which either actively locate tags or provide environmental context for devices to sense.

The idea of using radio frequency (RF), infrared, ultrasound, or combination of these technologies for indoor localization has been around for quite some time. A lot of research has been carried out in this area; however, still there is a huge gap in launching commercially successful models that provide indoor localization in a reliable, accurate, secure, cost efficient, easy-to-deploy and environmental friendly manner. One reason is that many approaches have technical drawbacks such as insufficient robustness in harsh environment and limitation on the number of items that can be located simultaneously.

Out of the above-mentioned technologies, radio frequency identification (RFID) is a rapidly developing technology which uses wireless communication for automatic identification of objects. It has been widely adopted as an attractive and cost-effective technology for applications like asset management, healthcare, and industrial automation. RFID-based localization systems have become popular due to the simplicity of attaching tags to target objects. Automatic localization and tracking of RFID tagged objects in their environment is becoming an important feature for many RFID based ubiquitous computing applications and robotics.

However, the development of an efficient and accurate indoor localization systems for indoor environments based on the existing passive RFID system is still a challenging task. The limitations usually stem from the harsh nature of the RF signal and other factors related to the RFID technology itself. Some of these factors of RFID technology that result in this limitation are: orientation of the RFID tag antenna; polarization; and sensitivity to metals and liquids. These effects make infeasible to construct a simple and accurate model of indoor RFID signals propagation. Any localization system should be built to overcome the high uncertainty caused by the behavior of the indoor wireless channels, while keeping the cost and the complexity of deployment as low as possible.

Research on location estimation of passive RFID tags is still in its infancy and most existing passive RFID indoor localization systems are simply focusing on determining the existence or non-existence information within the reader's interrogation area. In addition, most of other studies assume the ideal scenario of omnidirectional antennas for both the passive RFID tag and the reader.

Further, the received signal strength indication (RSSI) statistical distribution metric has also been used in radio ranging and learning to infer the targets' location. These techniques have received considerable attention lately due to its use in Wi-Fi networks that are being deployed in increasing numbers. The RSSI based approach for indoor localization is appealing for its low cost, although the estimation of the target is not of high accuracy. The extent of accuracy of target location is one of the most important objectives of indoor localization and any shortcoming in accuracy results in a low quality indoor localization system.

Specifically, most of the existing localization systems, are based on wireless technologies, such as, Wi-Fi, Zigbee, Bluetooth and active RFID, rely on the RSS measurement along with complicated localization algorithms to infer the target location. Unlike these technologies, passive RFID technology suffers from key additional issues, which severely affect the detection probability of the tags (that is, percentage of tags' detection in a reader's interrogation area) which is often about 60 to about 70 percent in real-world RFID deployments; and thereby affecting the accuracy and reliability of any RSS based passive RFID localization.

The primary issues that must be considered before designing any passive RFID-based localization system include: the antennas orientation and polarization matching for both the reader and the tag; tags placement and tags collision in dense environment. In most cases, the orientation of the reader and tag antennas cannot be precisely matched, causing loss in transmitted power. This will inevitably lead to unpredictable reading range even in environments that are free of material and radio interference. The antenna polarization can cause power loss in the link budget and its effects must be understood in a successful passive RFID environment. Regarding the tag placement, the loss creating dielectric or metallic surfaces, on which the passive RFID tags are placed and/or nearby objects and materials can affect the system performance. It may improve the performance by directing the reflected signal toward the system antenna or it may decrease performance by reflecting the signal away from the system antenna or by absorbing a portion of the signal. This phenomenon makes it difficult to measure and predict the correct RSSI from the tag. On the other hand, to improve the localization accuracy, it is desirable to increase the tag distribution density which can cause tags collision. Indeed, the multiple tags response will confuse the reader and could make it unable to identify any of the responding tags in their interrogation zone.

Accordingly, there is a need for a system and method that provide indoor localization in a reliable, accurate, secure, cost efficient, easy-to-deploy and environmental friendly manner.

### SUMMARY OF THE INVENTION

In view of the foregoing disadvantages inherent in the prior-art, the general purpose of the present invention is to provide a method and a system for RFID indoor localization that is configured to include all advantages of the prior art and to overcome the drawbacks inherent in the prior art offering some added advantages.

In one aspect, the present invention provides a system for RFID indoor localization for estimating location of a target object in a localization area, comprising: a radio frequency identification (RFID) unit comprising a RFID reader and a plurality of RFID antennas in operative communication with the RFID reader; and a central unit in operative communication with the RFID unit. The central unit is capable of configuring and distributing a plurality of passive reference tags in the localization area and further capable of: collecting data from the passive reference tags through the RFID unit; processing the collected data; and estimating location of the target object. The central unit employs learning-based location estimation by received signal strength indication (RSSI) and detection rate fingerprinting of passive reference tags and the use of tags with different backscattered range.

In another aspect, the present invention provides a method for RFID indoor localization for estimating location of a target object in a localization area. The method comprises: configuring a radio frequency identification (RFID) [unit and a central unit in operative communication with the RFID unit; configuring and distributing a plurality of passive reference tags by the central unit; transmitting data from the passive reference tags to the RFID unit to the central unit; processing of transmitted data by the central unit; and estimating location of the target object by the central unit. The central unit employs learning-based location estimation by received signal strength indication (RSSI) and detection rate fingerprinting of passive reference tags and the use of tags with different backscattered range.

These together with other aspects of the invention, along with the various features of novelty that characterize the invention, are pointed out with particularity in the claims annexed hereto and forming a part of this disclosure. For a better understanding of the invention, its operating advantages and the specific objects attained by its uses, reference should be had to the accompanying drawings and descriptive matter in which there are illustrated exemplary embodiments of the invention.

### BRIEF DESCRIPTION OF THE DRAWINGS

While the specification concludes with claims that particularly point out and distinctly claim the invention, it is believed that the advantages and features of the present invention will become better understood with reference to the following more detailed description of expressly disclosed exemplary embodiments taken in conjunction with the accompanying drawings. The drawings and detailed description which follow are intended to be merely illustrative of the expressly disclosed exemplary embodiments and are not intended to limit the scope of the present invention as set forth in the appended claims. In the drawings:

FIG. 1 depicts an overview of a system for indoor localization, according to an exemplary embodiment of the present invention;

FIG. 2 illustrates components of a central unit of the system for indoor localization of FIG. 1;

FIG. 3 illustrates concept of a backscattered range diversity; and

FIG. 4 depicts a flowchart of a method for indoor localization, according to an exemplary embodiment of the present invention.

Like reference numerals refer to like parts throughout the several views of the drawings.

### DETAILED DESCRIPTION OF THE INVENTION

The exemplary embodiments described herein detail for illustrative purposes are subject to many variations in structure and design. It should be emphasized, however, that the present invention is not limited to a particular method and system for RFID indoor localization, as shown and described. As used herein, “indoor localization” refers to process of inferring/estimating unknown location of one or more target objects based upon measurements learned from environment in which the one or more target objects are located.

It is understood that various omissions and substitutions of equivalents are contemplated as circumstances may suggest or render expedient, but these are intended to cover the application or implementation without departing from the spirit or scope of the claims of the present invention. Also, it is to be understood that the phraseology and terminology used herein is for the purpose of description and should not be regarded as limiting.

In the following description, for purposes of explanation, numerous specific details are set forth in order to provide a thorough understanding of the present invention. It will be apparent, however, to one skilled in the art that the present invention may be practiced without these specific details.

The system and method of the present invention provide indoor localization for estimating location of a target object in a reliable, accurate, secure, cost efficient, easy-to-deploy and environmental friendly manner. The system and method of the present invention implement learning-based radio frequency identification (RFID) real time indoor localization that employs a unique combination of tag detection probability, tag backscattered range diversity, and the measured received signal strength indication (RSSI) statistical distribution. As used herein, the ‘tag detection probability’ refers to detection rate of passive reference tags configured and distributed by the system of the present invention. Also, as used herein, ‘tag backscattered range diversity’ refers to the concept of using tags of varying reading range for localization, reducing learning area, and reducing searching time for reliable location estimation for a target object.

Specifically, the system of the present invention is a passive RFID localization system based on RSSI variation that considers both the effect of detection rate of passive reference tags and their backscattered range diversity to infer a target's location. More specifically, the system of the present invention employs a learning-based location estimation by received signal strength indication (RSSI) and detection rate fingerprinting of passive reference tags and the use of tags with different backscattered range.

Generally, the two main methods to perform indoor localization using RSSI are: ranging based methods and learning based methods. As mentioned above, the system of the present invention employs learning-based methods. Learning-based methods are widely adopted for Wi-Fi (or WLAN) indoor localization. The advantage of learning based method is that it can capture the complex radio profile in indoor environment such as, multipath, shadowing, non-line of sight (NLOS), time variation of RSS values at a fixed location, its dependence to the detected access points (APs) and other unpredictable factors (e.g. people moving, doors, and the like).

Unlike RADAR (an indoor tracking system based on the Wi-Fi and developed by a Microsoft research group) and LANDMARK (an RFID based positioning scheme that is in a way similar to RADAR scheme, except that the RF map is built by previously placed active tags), this invention uses a probabilistic map generated from passive reference tags with known locations to locate any unknown target detected by the passive RFID antennas. Several reference tags to sense the indoor environment are used. At the same time, consideration is taken of the parameters that affect the reading reliability described earlier by using the statistical detection rate model (which can follow Binomial distribution) in conjunction with the statistical model of tags backscattered RSSI (which can follow Gaussian distribution) to get more accurate RFID radio profile and calibration map. Such an approach enables efficient location inference using Map Matching Algorithms (MMA). In order to reduce the search for the best location candidate inside the localization area, the backscattered range diversity is applied. For the calibration map, which is used for localization, the detection rate of the passive RFID tag and the RSSI model are based on the reference tags' reading rate and RSSI model that are determined dynamically.

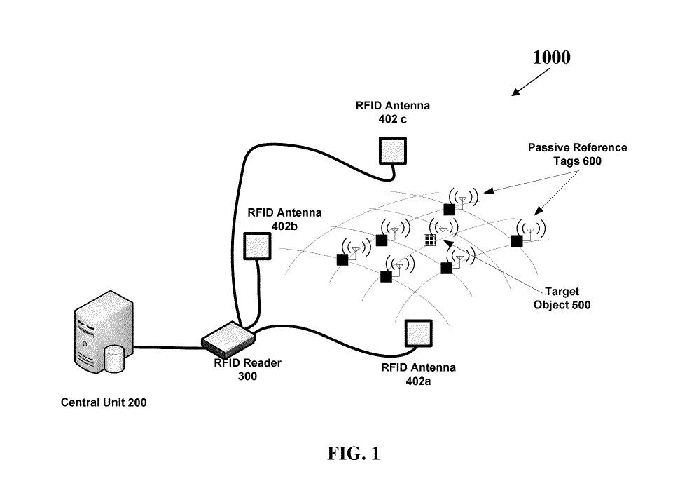

Referring to FIG. 1, shown is a system 1000 for indoor localization. The system 1000 is employed in a localization area for estimating location of one or more target objects, such as, a target object 500. As used herein, a ‘target object’ refers to an object whose location is to be estimated in a localization area. Also, as used herein, a ‘localization area’ refers to an interrogation area or an area of interest that has been selected for performing the indoor localization of the present invention. Specifically, the localization area is the environment in which the system 1000 is deployed. Further, although the system 1000 is described herein with reference to estimating location of the target object 500, it will be evident to a person skilled in the art to employ the system 1000 of the present invention for estimating locations for two or more target objects.

The system 1000 comprises: a radio frequency identification (RFID) unit comprising a RFID reader 300 and a plurality of RFID antennas 402a, 402b, 402c (hereinafter individually and collectively referred to as the RFID antennas 400) in operative communication with the RFID reader 300; and a central unit 200 in operative communication with the RFID unit. Further, a pre-defined number of passive reference tags 600 are employed in the system 1000 by the central unit 200 (specifically employed by a data collection module of the central unit 200 that is described below). The data from passive reference tags 600 is received by RFID antennas 400, transmitted to RFID reader 300 and thereafter to the central unit 200. As used herein, a ‘passive reference tag’ refers to RFID based landmarks or landmark tags that are configured and distributed for assisting in location estimation of the target object.

As used herein, ‘operative communication’ would refer to operational coupling/connection between two components through including wired means/network, wireless means/network or combinations thereof. An example of a wired network may be a local area network (LAN), fiber optic. Examples of wireless networks may include cellular networks, radio frequency communication, wireless LANs, Zigbee networks, dial-on modem, and the like.

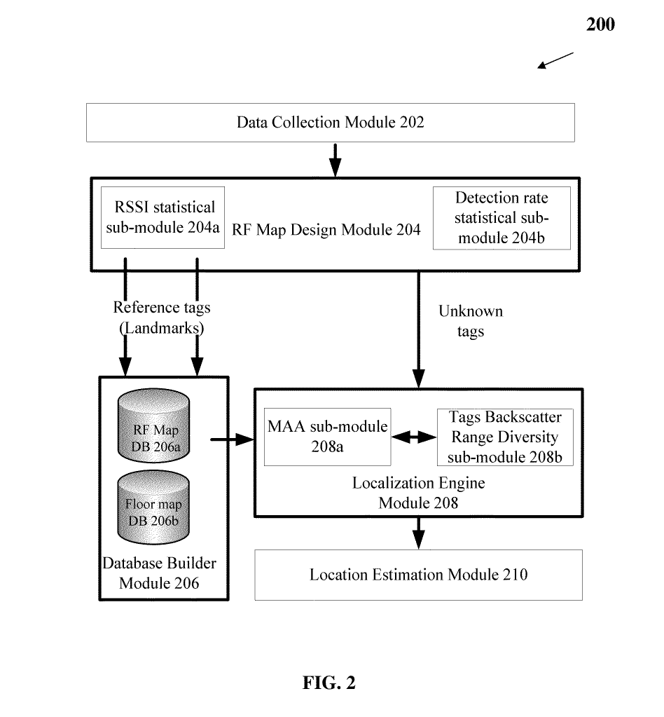

The central unit 200 is capable of: collecting data from the passive reference tags 600 through the RFID unit; processing the collected data; and estimating location of the target object 500 in the localization area. Referring to FIG. 2, illustrated are the components of the central unit 200 of the system 1000 of FIG. 1. The central unit 200 comprises: a data collection module 202 (also referred to as a ‘tags backscattered data collection module’); a radio frequency (RF) map design module 204; a database builder module 206; a localization engine module 208; and a localization estimation module 210.

The data collection module 202 employs data collection that is the primary concept of learning based localization techniques (also known as fingerprinting). The data collection module 202 configures and distributes a pre-defined number of passive reference tags 600 in the localization area based on a floor plan and initiates the construction of a radio frequency (RF) map. The data collection module 202 is capable of automatically detecting and collecting backscattered received signal strength indication (RSSI) received by each RFID reader antenna 400 and detection rate with their associated tag location. As used herein, a ‘floor plan’ refers to a drawing to scale, showing a view from above, of the relationships between rooms, spaces and other physical features at one level of a structure.

RFID reader antennas 400 are installed in the best way to cover the localized area (that is, the selected area) taking into consideration the directional radiation pattern of reader's antenna and the interrogation range, which is defined as the maximum distance at which the reader can recognize a tag. The backscattered RSSI of the passive reference tags 600 that are received by each reader's antenna are automatically detected and recorded with their associated tag location in a database (that will be described below as and RF map database) for location detection. Every fingerprinting approach starts with a mapping stage during which fingerprints are collected at known reference positions.

The RF map design module 204 is in operative communication with the data collection module 202. The RF map design module 204 receives input from the data collection module 202 to characterize the spatio-temporal properties of detection rate and received signal strength (RSS) through training RSS measurements at spatially distributed RFID passive reference tags (that is, the passive reference tags 600) with known coordinates. Generally, the RF map construction has to be performed prior to the operation of the positioning system during an off-line training session. However, for the RFID based localization system, this map can be constructed online, and can be dynamically adapted to the detection model of the changing environment. The location of an unknown tag is estimated by obtaining the signal strength and detection rate vector at the unknown tag and finding the closest matching vector from RF map designed by the RF map design module 204.

The RF map design module 204 is capable of successfully building the RF map using passive RFID tags. Due to the nature of RFID system operation, it is very common to obtain false negative reading (FNR). An FNR occurs when a tag is in the antenna coverage area but is not detected during a certain period of time. The RF map design module 204 of the system 1000 successfully addresses this issue and the RF map of the present invention is devoid of such FNRs.

As shown in FIG. 2, the RF map design module comprises two sub-modules: a RSSI statistical sub-module 204a; and a detection rate statistical sub-module 204b.

Now, the working of the RSSI statistical sub-module 204a is described. To design the RFID RSSI map [inside the reader's coverage area, we consider a finite set of L landmarks Γ={lᵢ, i=1 . . . L} (such as the passive reference tags 600) and finite number of the M RFID reader Antennas A={Aⱼ, j=1 . . . M} (such as the RFID antennas 400). The RSS fingerprints are carefully sampled at each reference position lᵢ as a vector {RSSₗ_{ᵢ}ⱼ, j=1 . . . M} received by N RFID reader antennas. The RSSₗ_{ᵢ}ⱼ is a random variable with a probability density function (pdf) p(RSSⱼ/lᵢ). In order to estimate this pdf, several methods can be used. In general density estimation takes two distinct forms, parametric and nonparametric, depending on prior knowledge of the parametric form of the density. If the parametric form p(x,\vec{θ}) is known up to the k parameters \vec{θ}=(θ₁, . . . θₖ), then the parameters may be estimated efficiently by Maximum Likelihood (ML) or Bayesian algorithms. For the nonparametric techniques, estimators such as Histogram and Kernel methods can be used.

In general, the statistical distribution of measured backscattered RSSI p(RSSⱼ/lᵢ) is generally assumed to be Gaussian and therefore, the RSSI statistical sub-module 204a generally employs a Multivariate Gaussian Distribution.

Now, the working of the detection rate statistical sub-module 204b is described. The RFID tag detection and reader reliable reading range remain the most critical issues for successful deployment of passive ultra high frequency (UHF) RFID systems in diverse applications. A significant number of tags which are within the reader's read range are not consistently read by the reader due to several issues which include tag location and orientation, multipath fading and communication blind spot. Furthermore, tag placement on a highly dielectric materials (i.e. liquids) or conductors (i.e. metal) can drastically change the properties of a tag antenna and thus reduce reading efficiency and shorten reading distance to the point of becoming completely unreadable at any distance in some scenarios.

The detection rate statistical sub-module 204b is capable of identifying the detection rate of the passive reference tags 600 by the RFID antennas 400 by estimating the tag response count in a fixed number of interrogation cycles sent from the antenna. The detection rate statistical sub-module employs a Binomial distribution. In general, the results of multiple reader interrogation cycles are collectively referred to as ‘epochs’ and each epoch is viewed as an independent Bernoulli trial with a probability (p_{D}) where:

$${p}_{D} = \frac{number of responses}{number of interrogation cycles} .$$

An RFID tag responds to the RFID antenna Aⱼ in one epoch with a probability p_{D,j}. This implies that the probability of getting kⱼ successful observations in N epochs is a random variable with a binomial distribution is:

$$B ( N , {p}_{D , j} ) = ( \begin{matrix}N \\ {k}_{j}\end{matrix} ) {{p}_{D , j}^{{k}_{j}} ( 1 - {p}_{D , j} )}^{N - {k}_{j}} .$$

On considering that each tag is detected independently from each reader's antenna: A={Aⱼ=1 . . . M}, then the probability that the tag at location lᵢ responds successfully kⁱⱼ times to the reader antenna Aⱼ in N epochs, is given by:

$$p ( Tags Detection Rate / {l}_{i} ) = {\prod }_{j = 1}^{M} ( \begin{matrix}N \\ {k}_{j}^{i}\end{matrix} ) {( {p}_{D , j}^{i} )}^{{k}_{j}^{i}} {( 1 - {p}_{D , j}^{i} )}^{N - {k}_{j}^{i}}$$

The database builder module 206 is in operative communication with the RF map design module 204. The database builder module 206 receives input from the RF map design module 204 to store the detection rate, RSSI distribution for each passive reference tag 600, location of passive reference tags, location of RFID antennas 400 and the floor plan of the localization area.

As shown in FIG. 2, the database builder module 206 comprises two sub-modules: a RF map database sub-module 206a; and a floor map database sub-module 206b. Specifically, the detection rate and the RSSI statistical distribution for each passive reference tag 600 are stored in RF map database sub-module 206a to be used by the localization engine module 208. The floor map database sub-module 206b stores all the information about location of passive reference tags, location of RFID antennas 400 and the floor plan of the localization area.

The localization engine module 208 is in operative communication with the RF map design module 204 and the database builder module 206. The localization engine module 208 receives input on the target object 500 from the RF map design module 204. Further, the localization engine module 208 receives input on passive reference tags 600 from the database builder module 206. The system 1000 of the present invention employs a probabilistic approach to infer the most likely location of the RFID tag from the RF map database sub-module 206a as the most probable location.

Referring to FIG. 2, the localization engine module 208 comprises two operatively coupled sub-modules: a map matching algorithm (MAA) sub-module 208a; and a tags backscatter range diversity sub-module 208b.

Now, the working of the MAA sub-module 208a is described. On considering that set of statistically independent observations from M RFID reader antennas S={sⱼ, j=1 . . . M} (such as, RFID antenna 400) is collected in an unknown location x, the estimated location of the target \hat{x} can be computed by maximizing the joint likelihood l(x) with respect to x:

$${{x}^{⋒}}_{MLE} = {arg max}_{x} l ( x ) = {arg max}_{x} p ( S / x )$$

$${{x}^{⋒}}_{MLE} = {arg max}_{x} {\prod }_{j < M} {p}_{j} ( {s}_{j} / x )$$

The conditional probability pⱼ(sⱼ/x) is called the likelihood of the observation sj from the j^{th} reader antenna, given the parameter x (location). Considering that the RSSI statistical module 204a and the detection rate statistical sub-module 204b are statistically independent, this likelihood function can be derived from the RF map design module 204 as follows:

pⱼ(sⱼ/x)=pⱼ^{RSS}(sⱼ/x)pⱼ^{D}(sⱼ/x)

where pⱼ^{RSS}(sⱼ/x) can follow a Gaussian distribution and pⱼ^{D}(sⱼ/x) can follow Binomial distribution. Accordingly, the MAA sub-module 208a implements a map matching algorithm on inputs from the RSSI statistical sub-module 204a in conjunction with the detection rate statistical sub-module 204b to get the more accurate RFID radio profile and calibration map.

The passive reference tags 600 transfers data to the RFID reader 300 using radio waves that are tuned to the same frequency as of the RFID reader 300 and within the reading range of the RFID reader 300. The performance of the passive reference tags 600 is determined by factors such as the type of integrated circuit (IC) used, the read/write capability, the radio frequency band, the reading range, and external factors such as the environment and packaging. Currently, there are several types of UHF passive RFID tags with different reading range.

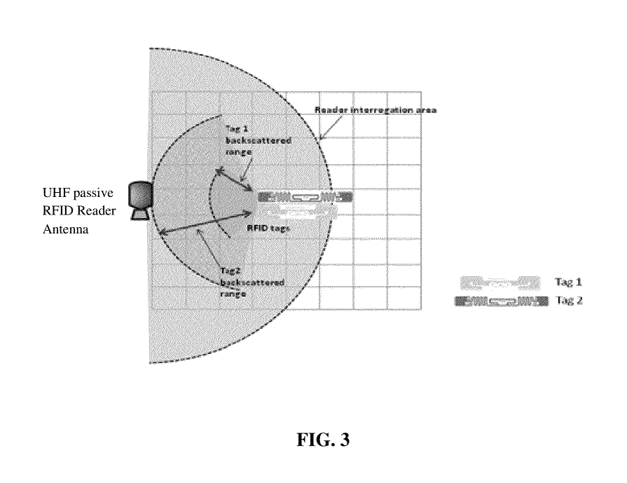

The tags backscattered range diversity sub-module 208b is capable of reducing the learning area used by the MAA sub-module 208a. In one embodiment, two passive tags with different reading range are attached for each target object (such as, target object 500). The target object only, will be attached by two types of RFID tags with different reading range. First is long range and second is short range. The reference tags should have the same type of tags attached to the target object with long range. The tag with longer reading range will be used for localization while the tag with lower reading range will be used to reduce the learning area and searching time to infer the best location candidate of the target inside the localization area. Referring to FIG. 3, illustrated is such a concept of the backscattered range diversity. In FIG. 3, Tag 1 is the tag with the lower reading range for reducing the learning area, while Tag 2 is the tag with the higher reading range used for localization. As used herein, localization refers to measuring location estimates of the target object 500.

The location estimation module 210 finally collects all of the measured location estimates of the target object from the localization engine module 208 and is capable of using filtering techniques to estimate the location of the target object 500.

Accordingly, a learning-based indoor localization is achieved based on probabilistic RF map made from detection rate probability and RSSI data distribution. RF Map is generated by a combination of the RSSI map and detection rate map. For each reference tag, an RSSI and detection rate (DR) distribution are measured. Such a statistical RF map will model the location estimation variation inside the localization area, and helps to improve the accuracy and precision of the target location. The detection rate probability for a specific tag is estimated by the number of reads (tag response) counted in a fixed number of interrogation cycles or epochs sent from the reader antenna. Here, each epoch can be viewed as an independent Bernoulli trial with a success probability p. In general, RSS data is an ideal modality for location estimation in wireless networks because RSS information can be obtained at no additional cost with each radio message sent and received.

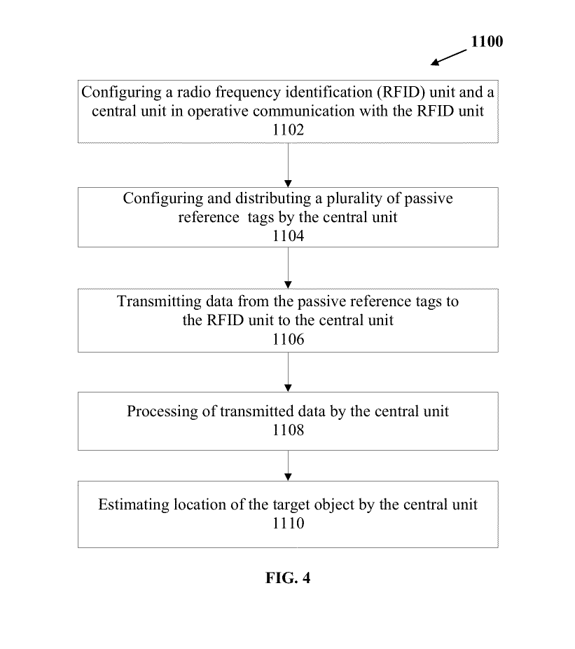

FIG. 4 illustrates a flow diagram of a method 1100 employed by a system of the present invention (such as system 1000 of FIG. 1) for indoor localization for estimating location of a target object in a localization area. The method comprises: configuring a radio frequency identification (RFID) unit and a central unit in operative communication with the RFID unit at step 1102; configuring and distributing a plurality of passive reference tags by the central unit at step 1104; transmitting data from the passive reference tags to the RFID unit to the central unit at step 1106; processing of transmitted data by the central unit at step 1108; and estimating location of the target object by the central unit at step 1110. The central unit employs estimation by received signal strength indication (RSSI) as a function of detection rate of passive reference tags and use of tags of varying reading range.

Also, techniques, devices, subsystems and methods described and illustrated in the various embodiments as discrete or separate may be combined or integrated with other systems, modules, techniques, or methods without departing from the scope of the present technology. Other items shown or discussed as directly coupled or communicating with each other may be coupled through some interface or device, such that the items may no longer be considered directly coupled to each other but may still be indirectly coupled and in communication, whether electrically, mechanically, or otherwise, with one another. Other examples of changes, substitutions, and alterations ascertainable by one skilled in the art, upon studying the exemplary embodiments disclosed herein, may be made without departing from the spirit and scope of the present technology.

In various exemplary embodiments of the present invention, the method discussed herein, e.g., with reference to FIG. 4, may be supplemented with operations implemented through computing devices such as hardware, software, firmware, or combinations thereof, which may be provided as a computer program product, e.g., including a machine-readable or computer-readable medium having stored thereon instructions or software procedures used to program a computer to perform a process discussed herein. The machine-readable medium may include a storage device. In other instances, well-known devices, methods, procedures, components, and circuits have not been described herein so as not to obscure the particular embodiments of the present invention. Further, various aspects of embodiments of the present invention may be performed using various means, such as integrated semiconductor circuits, computer-readable instructions organized into one or more programs, or some combination of hardware and software.

It should be noted that reference throughout this specification to features, advantages, or similar language does not imply that all of the features and advantages should be or are in any single embodiment. Rather, language referring to the features and advantages may be understood to mean that a specific feature, advantage, or characteristic described in connection with an embodiment may be included in at least one embodiment of the present technology. Thus, discussions of the features and advantages, and similar language, throughout this specification may, but do not necessarily, refer to the same embodiment.

What is claimed is:

1. A system for radio frequency identification (RFID) indoor localization for estimating location of a target object in a localization area, comprising:
a radio frequency identification (RFID) unit comprising a RFID reader and a plurality of RFID antennas in operative communication with the RFID reader; and
a central unit in operative communication with the RFID unit, the central unit capable of configuring and distributing a plurality of passive reference tags in the localization area;
wherein the central unit is capable of
collecting data from the passive reference tags through the RFID unit,
processing the collected data, and
estimating location of the target object, and
wherein the central unit employs learning-based location estimation by received signal strength indication (RSSI) and detection rate fingerprinting of passive reference tags and the use of tags with different backscattered range.

2. The system of claim 1, wherein the central unit comprises
a data collection module for configuring and distributing the pre-defined number of passive reference tags in the localization area based on a floor plan and initiating the construction of a radio frequency (RF) map, wherein the data collection module is capable of automatically detecting and collecting backscattered received signal strength indication (RSSI) received by each RFID antenna, detection rate with their associated tag location,
a radio frequency (RF) map design module in operative communication with the data collection module, wherein the RF map design module receives input from the data collection module to characterize the spatio-temporal properties of detection rate and received signal strength (RSS) through training RSS measurements at the passive reference tags with known coordinates to build the RF map,
a database builder module in operative communication with the RF map design module, wherein the database builder module receives input from the RF map design module to store detection rate and RSSI statistical distribution for each passive reference tag, location of passive reference tags, location of RFID antennas and the floor plan of the localization area,
a localization engine module in operative communication with the RF map design module and the database builder module, wherein the localization engine module receives input on the target object from the RF map design module, and wherein the localization engine module receives input on passive reference tags from the database builder module, and
a location estimation module in operative communication with the localization engine module, wherein the location estimation module receives input on all measured location estimates from the localization engine, and wherein the location estimation module is capable of filtering the different location estimates to estimate location of the target object.

3. The system of claim 2, wherein the location of the target object is estimated by obtaining a signal strength and detection rate vector at the target object and identifying the closest matching vector from the RF map.

4. The system of claim 2, wherein the RF map design module comprises
a RSSI statistical sub-module, and
a detection rate statistical sub-module.

5. The system of claim 4, wherein the RSSI statistical sub-module employs a Multivariate Gaussian Distribution and detection rate statistical sub-module employs a Binomial distribution.

6. The system of claim 4, wherein the detection rate statistical module is capable of identifying the detection rate of the passive reference tags by the RFID antenna by estimating the tag response count in a fixed number of interrogation cycles sent from the RFID antenna.

7. The system of claim 2, wherein the database builder module comprises
an RF map database sub-module capable of storing detection rate and RSSI distribution for each passive reference tag, and
a floor map database sub-module capable of storing location of passive reference tags, location of RFID antennas and the floor plan of the localization area.

8. The system of claim 4, wherein the localization engine comprises
a map matching algorithm (MAA) sub-module capable of implementing a map matching algorithm on inputs from the RSSI statistical sub-module in conjunction with the detection rate statistical sub-module, and
a tags backscatter range diversity sub-module capable of reducing the learning area and searching time used by the MAA sub-module.

9. The system of claim 8, wherein the tags backscatter range diversity sub-module is capable processing data from a first passive reference tag with a longer reading range and a second passive reference tag having a lower reading range, wherein the first passive reference tag is capable of localization, and wherein the second passive reference tag is capable of reducing the learning area and the searching time.

10. A method for RFID indoor localization for estimating location of a target object in a localization area, comprising:
configuring a radio frequency identification (RFID) unit and a central unit in operative communication with the RFID unit;
configuring and distributing a plurality of passive reference tags by the central unit;
transmitting data from the passive reference tags to the RFID unit to the central unit;
processing of transmitted data by the central unit; and
estimating location of the target object by the central unit;
wherein the central unit employs learning-based location estimation by received signal strength indication (RSSI) and detection rate fingerprinting of passive reference tags and the use of tags with different backscattered range.

11. The method of claim 10, wherein the RFID unit comprises a RFID reader and a plurality of antennas in operative communication with the RFID reader.

12. The method of claim 10, wherein the central unit comprises
a data collection module for configuring and distributing the pre-defined number of passive reference tags in the localization area based on a floor plan and initiating the construction of a radio frequency (RF) map, wherein the data collection module is capable of automatically detecting and collecting backscattered received signal strength indication (RSSI) received by each RFID antenna, detection rate with their associated tag location,
a radio frequency (RF) map design module in operative communication with the data collection module, wherein the RF map design module receives input from the data collection module to characterize the spatio-temporal properties of detection rate and received signal strength (RSS) through training RSS measurements at the passive reference tags with known coordinates to build the RF map,
a database builder module in operative communication with the RF map design module, wherein the database builder module receives input from the RF map design module to store detection rate and RSSI statistical distribution for each passive reference tag, location of passive reference tags, location of RFID antennas and the floor plan of the localization area,
a localization engine module in operative communication with the RF map design module and the database builder module, wherein the localization engine module receives input on the target object from the RF map design module, and wherein the localization engine module receives input on passive reference tags from the database builder module, and
a location estimation module in operative communication with the localization engine module, wherein the location estimation module receives input on all measured location estimates from the localization engine, and wherein the location estimation module is capable of filtering the different location estimates to estimate location of the target object.

13. The method of claim 12, wherein the location of the target object is estimated by obtaining a signal strength and detection rate vector at the target object and identifying the closest matching vector from the RF map.

14. The method of claim 12, wherein the RF map design module comprises
a RSSI statistical sub-module, and
a detection rate statistical sub-module.

15. The method of claim 14, wherein the RSSI statistical sub-module employs a Multivariate Gaussian Distribution and the detection rate statistical sub-module employs a Binomial distribution.

16. The method of claim 14, wherein the detection rate statistical module is capable of identifying the detection rate of the passive reference tags by the RFID antenna by estimating the tag response count in a fixed number of interrogation cycles sent from the RFID antenna.

17. The method of claim 12, wherein the database builder module comprises
an RF map database sub-module capable of storing detection rate and RSSI distribution for each passive reference tag, and
a floor map database sub-module capable of storing location of passive reference tags, location of RFID antennas and the floor plan of the localization area.

18. The method of claim 14, wherein the localization engine comprises
a map matching algorithm (MAA) sub-module capable of implementing a map matching algorithm on inputs from the RSSI statistical sub-module in conjunction with the detection rate statistical sub-module, and
a tags backscatter range diversity sub-module capable of reducing the learning area and searching time used by the MAA sub-module.

19. The method of claim 18, wherein the tags backscatter range diversity sub-module is capable processing data from a first passive reference tag with a longer reading range and a second passive reference tag having a lower reading range, wherein the first passive reference tag is capable of localization, and wherein the second passive reference tag is capable of reducing the learning area and the searching time.
